(19) United States
(12) Patent Application Publication
(10) Pub. No.: US 2025/0118914 A1
(43) Pub. Date: Apr. 10, 2025

(54) Connector Assembly and Socket Connector

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Hua (Andy) Li, Shanghai (CN); Wei Yao, Kunshan (CN); Michael James Horning, Middletown, PA (US); Chenglong Huang, Dongguan (CN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 18/907,653

(22) Filed: Oct. 7, 2024

(30) Foreign Application Priority Data
Oct. 7, 2023 (CN) 202311289487.5

(51) Int. Cl. H01R 12/71; H01R 12/70

(52) U.S. Cl. CPC H01R 12/718; H01R 12/7005

(57) ABSTRACT

A connector assembly includes a printed circuit board having a first electrical pin and a second electrical pin positioned on the printed circuit board, a socket connector including an insulation housing having a first socket and a second socket, and a locker movable between a first position and a second position. The first electrical pin is removably inserted into the first socket and the second electrical pin is removably inserted into the second socket. The insulation housing has a locking cavity communicated with the first socket. The locker engages with the first electrical pin to lock the first electrical pin in the first socket in the first position, and the locker disengages from the first electrical pin to release the locking of the first electrical pin in the second position.

### CROSS-REFERENCE TO RELATED APPLICATION

This application claims the benefit of the filing date under 35 U.S.C. § 119 (a)-(d) of Chinese Patent Application No. 202311289487.5, filed on Oct. 7, 2023.

### FIELD OF THE INVENTION

Embodiments of the present disclosure generally relate to a technical field of electrical connection(s), and in particular, to a connector assembly and a socket connector.

### BACKGROUND OF THE INVENTION

A common type of connection in connector systems is a plug-and-socket connection. Generally, signal transmission and/or power transmission between an electrical component (such as a circuit on a printed circuit board) to which a plug connector is connected and an electrical component (such as an electrical cable) to which a socket connector is connected is achieved by inserting a plug (such as an electrical pin) of the plug connector into a socket of the socket connector and contacting an electrical connection terminal in the socket. The stability of the connection between the plug of the plug connector and the socket (as well as the electrical connection terminal) of the socket connector is important, as is a need for repeated plugging and unplugging between the plug and the socket for such plug-and-socket connection.

A locking structure is generally used to stabilize the connection between the plug of the plug connector and the socket (as well as the electrical connection terminal) of the socket connector. However, in this solution, one locking structure is provided for each pair of plug and sockets mated each other, which not only complicates structures of the plug connector and the socket connector, but also does not facilitate the plugging and unplugging operation between the plug connector and the socket connector, requiring large installation space. Further, it increases the manufacturing cost of the connectors.

### SUMMARY OF THE INVENTION

A connector assembly includes a printed circuit board having a first electrical pin and a second electrical pin positioned on the printed circuit board, a socket connector including an insulation housing having a first socket and a second socket, and a locker movable between a first position and a second position. The first electrical pin is removably inserted into the first socket and the second electrical pin is removably inserted into the second socket. The insulation housing has a locking cavity communicated with the first socket. The locker engages with the first electrical pin to lock the first electrical pin in the first socket in the first position, and the locker disengages from the first electrical pin to release the locking of the first electrical pin in the second position.

### BRIEF DESCRIPTION OF THE DRAWINGS

Features of the present disclosure will become more apparent by describing in detail exemplary embodiments thereof with reference to the accompanying drawings, in which:

FIG. 1 is a schematic perspective structural view showing a socket connector according to an exemplary embodiment of the present disclosure;

FIG. 2 is a schematic perspective structural view showing a connector assembly including the socket connector shown in FIG. 1 according to an exemplary embodiment of the present disclosure;

FIG. 3 is a schematic cross-sectional view showing the connector assembly according to the exemplary embodiment of the present disclosure;

FIG. 4 is another schematic cross-sectional view showing the connector assembly according to the exemplary embodiment of the present disclosure;

FIG. 5 is a schematic enlarged perspective structural view showing a locker of the connector assembly according to the exemplary embodiment of the present disclosure; and

FIG. 6 is a schematic enlarged perspective structural view showing a first electrical pin of the connector assembly according to the exemplary embodiment of the present disclosure.

### DETAILED DESCRIPTION

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

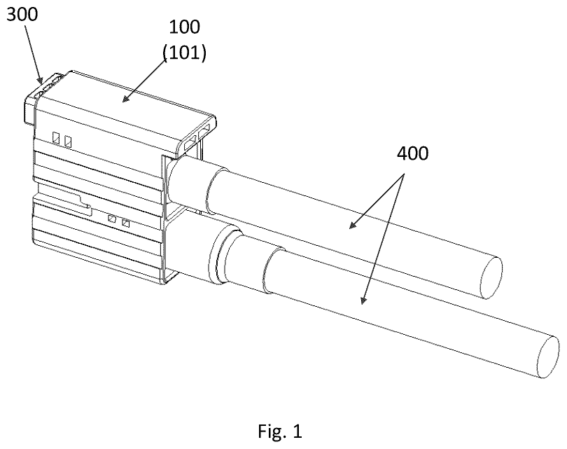

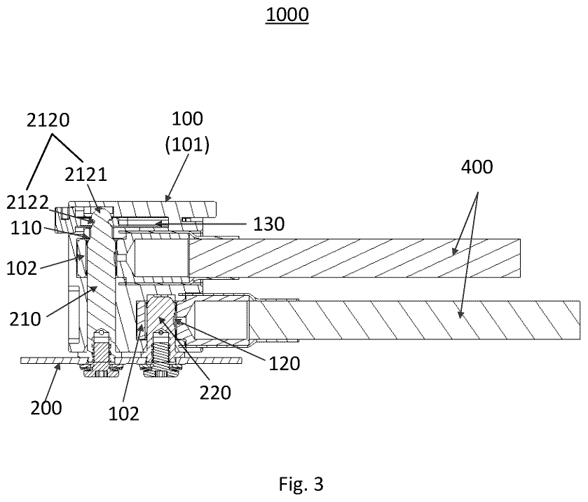

FIG. 1 is a schematic perspective structural view showing a socket connector 100 according to an exemplary embodiment of the present disclosure. It should be noted that in addition to showing the socket connector 100, FIG. 1 also shows cables 400 connected to various sockets (see 110 and 120 in FIG. 3) of the socket connector 100.

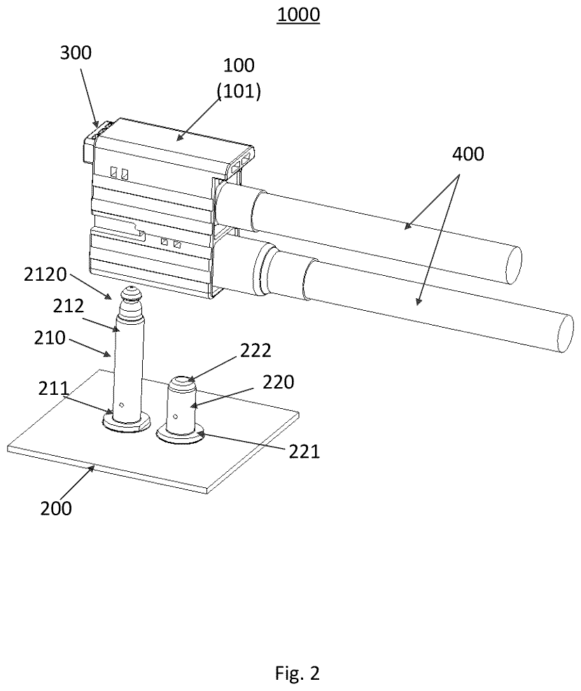

FIG. 2 is a schematic perspective structural view showing a connector assembly 1000 according to an exemplary embodiment of the present disclosure. In FIG. 2, not only the socket connector 100 connected with cables 400 as shown in FIG. 1 is shown, but also a printed circuit board 200, which is mated with the socket connector 100, with electrical pins 210, 220 is shown. In FIG. 2, the electrical pins 210, 220 on the printed circuit board 200 have not been inserted into the various sockets (see 110 and 120 in FIG. 3) of the socket connector 100. It should be noted that although only the two electrical pins 210, 220 on the printed circuit board 200 being electrically connected to two cables 400 by the socket connector 100, respectively, are shown in FIGS. 1 and 2 and subsequent figures, the socket connector 100 according to the exemplary embodiments of the present disclosure may be also electrically connected to a larger number of electrical pins and corresponding cables, and this is not limited herein.

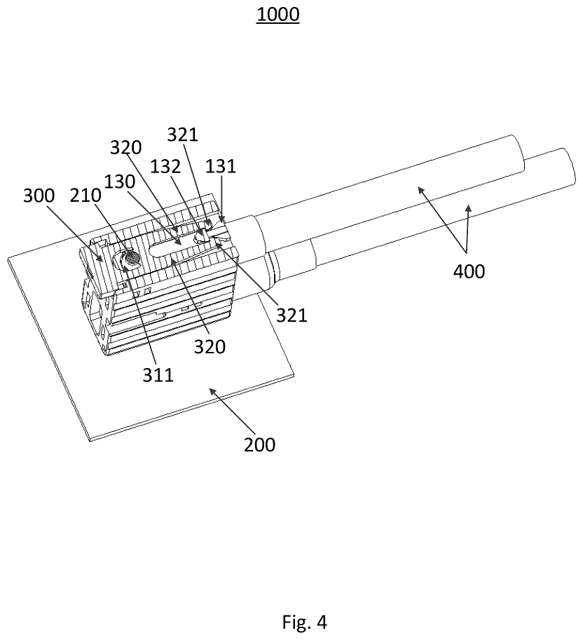

FIGS. 3 and 4 are schematic cross-sectional views showing the connector assembly according to the exemplary embodiment of the present disclosure, respectively. FIGS. 3 and 4 show internal structure of the connector assembly, specifically, fitting relationships between the electrical pins 210, 220, the sockets 110, 120, a locker 300 and cables 400.

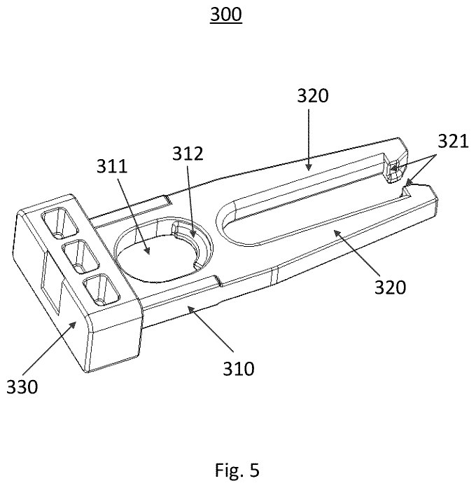

FIG. 5 is a schematic enlarged structural view showing the locker 300 of the connector assembly 1000 according to the exemplary embodiment of the present disclosure.

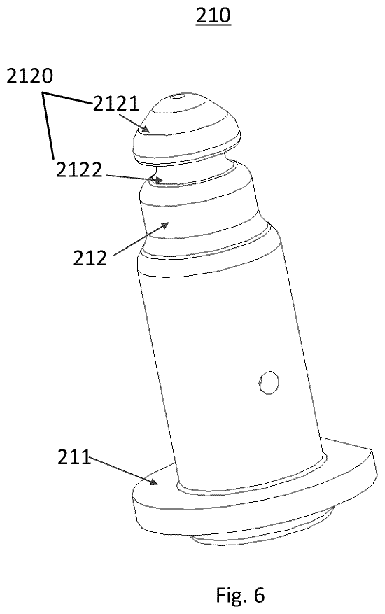

FIG. 6 is a schematic enlarged structural view showing a first electrical pin 210 of the connector assembly 1000 according to the exemplary embodiment of the present disclosure.

Referring to FIGS. 1 to 6, according to one aspect of the present disclosure, there is provided the connector assembly 1000. The connector assembly 1000 includes the printed circuit board 200, the socket connector 100, and the locker 300 movably provided in the socket connector 100.

According to the exemplary embodiments of the present disclosure, as shown in FIG. 2, the printed circuit board 200 has installed thereon a first electrical pin 210 and a second electrical pin 220 for electrical connection. As shown in FIGS. 2 and 3, the socket connector 100 includes an insulation housing 101 formed with a first socket 110 and a second socket 120. According to the present disclosure, the insulation housing 101 and the locker 300 are made of insulation materials such as plastic, and the electrical pins 210, 220 are made of conductive materials such as copper metal.

The first electrical pin 210 is removably inserted into the first socket 110, and the second electrical pin 220 is removably inserted into the second socket 120. The insulation housing 101 is also formed with a locking cavity 130 communicated with the first socket 110. The locker 300 is movably provided in the locking cavity 130 and is able to move between a first position and a second position. When in the first position (as shown in FIG. 3), the locker 300 engages with the first electrical pin 210 to lock the first electrical pin 210 in the first socket 110, and when in the second position, the locker 300 disengages from the first electrical pin 210 to release the locking of the first electrical pin 210. According to the present disclosure, a length of the first electrical pin 210 is greater than that of the second electrical pin 220 on the printed circuit board 200; correspondingly, a length of the first socket 110 is greater than that of the second socket 120 in the socket connector 100.

As long as only a locking action on the first electrical pin 210 inserted into and engaged with the first socket 110 is performed by the locker 300, all electrical pins 210, 220 installed on the printed circuit board 200 are stably maintained in the corresponding sockets 110, 120 of the socket connector 100 to ensure the stability of the connections between the electrical pins 210, 220 and the electrical connection terminals (102 as shown in FIG. 3) in the socket connector 100, and thus ensure the stability of the connections between the electrical pins and the cables through the socket connector 100. In this way, compared with the related art that requires performing a locking action on each electrical pin 210, with the connector assembly according to the present disclosure, the stability of the connections between all electrical pins 210, 220 and the corresponding cables is ensured as long as a locking action is performed on only one electrical pin 210 of the two or more electrical pins 210, 220. Therefore, it has a simplified structure, is easy to operate, saves cost, and meets the installation requirements of small width and space. It should be noted that although only one second electrical pin 220 and one corresponding second socket 120 are shown in the illustrated embodiments, other numbers of the second electrical pins 220 and other numbers of the corresponding second sockets 120 may be provided according to the requirements of actual design.

According to the exemplary embodiments of the present disclosure, as shown in FIGS. 2, 3 and 6, specifically, the first electrical pin 210 has a first installation end 211 and a first free end 212. The first installation end 211 is connected to a circuit path of the printed circuit board 220, and the first free end 212 is formed with a locking engaging portion 2120. As shown in FIG. 3, the locking engaging portion 2120 of the first electrical pin 210 extends out of the first socket 110 and into the locking cavity 130.

As shown in FIGS. 3 and 6, the locking engaging portion 2120 of the first electrical pin 210 is a mushroom shape with a cover-shaped portion 2121 and a stem-shaped portion 2122, the stem-shaped portion 2122 extending from the first free end 212, and the cover-shaped portion 2121 extending from the stem-shaped portion 2122. According to the present disclosure, when the first electrical pin 210 on the printed circuit board 200 is inserted into and engaged with the first socket 110 of the socket connector 100, the stem-shaped portion 2122 of the locking engaging portion 2120 enters the locking cavity 130 through the first socket 110. At this time, when the locker 300 is in the first position, the locker 300 clamps the stem-shaped portion 2122 entering the locking cavity 130 to achieve the locking of the first electrical pin 210 by the locker 300. When the locker 300 is in the second position, the locker 300 releases the clamping of the stem-shaped portion 2122 entering the locking cavity 130 to release the locking of the first electrical pin 210 by the locker 300.

According to the exemplary embodiments of the present disclosure, as shown in FIGS. 2 and 3, the second electrical pin 220 has a second installation end 221 and a second free end 222. The second installation end 221 is connected to the printed circuit board 300, and the second free end 222 has a truncated cone shape. According to the design concept of the present disclosure, a length of the remaining portion of the first electrical pin 210 except the locking engaging portion 2120 is greater than an overall length of the second electrical pin 220. That is to say, according to the present disclosure, the overall length of the first electrical pin 210 is longer, and other second electrical pins 220 have shorter overall lengths, which can save costs and meet the installation requirements of smaller width and space.

According to the exemplary embodiments of the present application, specifically, as shown in FIGS. 3 to 5, the locker 300 further includes a main body 310, a pair of elastic arms 320 and an operating portion 330. The main body 310 is provided with a locking window 311, a locking flange 312 protruding towards a center of the locking window 311 is formed at an inner edge of the locking window 311, and the locking window 311 is adapted to allow the locking engaging portion 2120 of the first electrical pin 210 to pass therethrough and lock the stem-shaped portion 2122 of the locking engaging portion 2120 by the locking flange 312. The pair of elastic arms 320 extend from the main body 310 and are separated from each other, and each elastic arm 320 is formed with a hook member 321, which is extending towards the other elastic arm 320, at its free end. The operating portion 330 is provided on a side of the main body 310 opposite to the pair of clastic arms 320.

According to the exemplary embodiments of the present disclosure, specifically, as shown in FIGS. 4 to 5, a locking cavity 130, which is mated with the locker 300, is formed in the insulation housing 101 of the socket connector 100. The locking cavity 130 is provided with a guiding block 131 and a stopping block 132, the stopping block 132 being closer to the first socket 110 than the guiding block 131. The main body 310 of the locker 300 and the pair of elastic arms 320 are accommodated in the locking cavity 130, wherein the hook members 321 of the pair of elastic arms 320 of the locker 300 are positioned between the guiding block 131 and the stopping block 132. Specifically, as the locker 300 moves from the first position to the second position, the hook members 321 of the pair of elastic arms 320 move away from each other under the guidance of the guiding block 131. As the locker 300 moves from the second position to the first position, the hook members 321 of the pair of elastic arms 320 move toward each other under the guidance of the guiding block 131. The locker 300 is positioned in the first position in the normal state, and when the locker 300 is pressed through the operating portion 330, the locker 300 moves from the first position to the second position, at this time, the first electrical pin 210 may be inserted into the first socket 110 or removed from the first socket 110.

According to another aspect of the present disclosure, there is provided a socket connector 100, as shown in FIGS. 1 to 3. The socket connector 100 includes an insulation housing 101 and a locker 300. In an embodiment, the insulation housing 101 is formed with a first socket 110 into which a first electrical pin 210 adapted to be installed on the printed circuit board 200 is inserted, and a second socket 120 into which a second electrical pin 220 adapted to be installed on the printed circuit board 200 is inserted, a length of the first socket 110 being greater than that of the second socket 120. The insulation housing 101 is further formed with a locking cavity 130 communicated with the first socket 110. The locker 300 is movably provided in the locking cavity 130 and is able to move between a first position and a second position.

According to the present disclosure, a length of the first socket 110 is greater than that of the second socket 120 in the socket connector 100. As long as only a locking action on the first electrical pin 210 inserted into and engaged with the first socket 110 is performed by the locker 300, all electrical pins 210, 220 installed on the printed circuit board 200 are stably maintained in the corresponding sockets 110, 120 of the socket connector 100 to ensure the stability of the connections between the electrical pins and the electrical connection terminals (102 as shown in FIG. 3) in the socket connector 100, and thus ensure the stability of the connections between the electrical pins and the cables by the socket connector.

According to the exemplary embodiments of the present disclosure, specifically, as shown in FIGS. 3 to 5, the locker 300 further includes a main body 310, a pair of elastic arms 320 and an operating portion 330. The main body 310 is provided with a locking window 311, a locking flange 312 protruding towards a center of the locking window 311 is formed at an inner edge of the locking window 311, and the locking window 311 is adapted to allow the locking engaging portion 2120 of the first electrical pin 210 to pass therethrough and lock the stem-shaped portion 2122 of the locking engaging portion 2120 by the locking flange 312. The pair of elastic arms 320 extend from the main body 310 and are separated from each other, and each elastic arm 320 is formed with a hook member 321, which is extending towards the other elastic arm 320, at its free end. The operating portion 330 is provided on a side of the main body 310 opposite to the pair of elastic arms 320.

As shown in FIGS. 4 to 5, a locking cavity 130, which is mated with the locker 300, is provided with a guiding block 131 and a stopping block 132, the stopping block 132 being closer to the first socket 110 than the guiding block 131. The hook members 321 of the pair of elastic arms 320 are positioned between the guiding block 131 and the stopping block 132. As the locker 300 moves from the first position to the second position, the hook members 321 of the pair of elastic arms 320 move away from each other under the guidance of the guiding block 131. As the locker 300 moves from the second position to the first position, the hook members 321 of the pair of elastic arms 320 move toward each other under the guidance of the guiding block 131.

The socket connector 100 provided by the exemplary embodiments of the present disclosure has simplified structure, is easy to operate, saves cost, and meets the installation requirements of small width and space.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example and should not be construed as limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in the claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

1. A connector assembly, comprising:
a printed circuit board having a first electrical pin and a second electrical pin positioned on the printed circuit board, a length of the first electrical pin is greater than a length of the second electrical pin;
a socket connector including an insulation housing having a first socket and a second socket, a length of the first socket is greater than a length of the second socket, the first electrical pin is removably inserted into the first socket and the second electrical pin is removably inserted into the second socket, the insulation housing has a locking cavity communicated with the first socket; and
a locker disposed in the locking cavity and movable between a first position and a second position, the locker engages with the first electrical pin to lock the first electrical pin in the first socket in the first position, the locker disengages from the first electrical pin to release the locking of the first electrical pin in the second position.

2. The connector assembly of claim 1, wherein the first electrical pin has a first installation end and a first free end, the first installation end is connected to the printed circuit board, the first free end has a locking engaging portion.

3. The connector assembly of claim 2, wherein the locking engaging portion of the first electrical pin extends out of the first socket and into the locking cavity.

4. The connector assembly of claim 3, wherein the locking engaging portion is a mushroom shape with a cover-shaped portion and a stem-shaped portion, the stem-shaped portion extending from the first free end, and the cover-shaped portion extending from the stem-shaped portion.

5. The connector assembly of claim 4, wherein the stem-shaped portion of the locking engaging portion enters the locking cavity.

6. The connector assembly of claim 5, wherein the locker clamps the stem-shaped portion entering the locking cavity when the locker is in the first position, the locker releases clamping of the stem-shaped portion entering the locking cavity when the locker is in the second position.

7. The connector assembly of claim 6, wherein the second electrical pin has a second installation end and a second free end, the second installation end is connected to the printed circuit board, the second free end has a truncated cone shape.

8. The connector assembly of claim 7, wherein a length of a remaining portion of the first electrical pin other than the locking engaging portion is greater than the length of the second electrical pin.

9. The connector assembly of claim 6, wherein the locker includes a main body having a locking window, a locking flange protruding towards a center of the locking window at an inner edge of the locking window, the locking window allowing the locking engaging portion of the first electrical pin to pass therethrough and lock the stem-shaped portion of the locking engaging portion by the locking flange.

10. The connector assembly of claim 9, wherein the locker includes a pair of elastic arms extending from the main body and separated from each other, each elastic arm has a hook member extending towards the other elastic arm at a free end.

11. The connector assembly of claim 10, wherein the locker includes an operating portion on a side of the main body opposite to the pair of elastic arms.

12. The connector assembly of claim 11, wherein the locking cavity has a guiding block and a stopping block, the stopping block is closer to the first socket than the guiding block, the hook members are between the guiding block and the stopping block.

13. The connector assembly of claim 12, wherein the hook members of the pair of elastic arms move away from each other under guidance of the guiding block as the locker moves from the first position to the second position.

14. The connector assembly of claim 13, wherein the hook members of the pair of elastic arms move toward each other under guidance of the guiding block as the locker moves from the second position to the first position.

15. A socket connector, comprising:
an insulation housing having a first socket into which a first electrical pin installed on a printed circuit board is inserted and a second socket into which a second electrical pin installed on the printed circuit board is inserted, a length of the first socket is greater than a length of the second socket, the insulation housing has a locking cavity communicated with the first socket; and
a locker movably provided in the locking cavity and movable between a first position and a second position, the locker engages with the first electrical pin inserted into the first socket to lock the first electrical pin in the first socket in the first position, the locker disengages from the first electrical pin inserted into the first socket to release the locking of the first electrical pin in the second position.

16. The socket connector of claim 15, wherein the locker includes a main body having a locking window, a locking flange protruding towards a center of the locking window at an inner edge of the locking window, the locking window allowing the locking engaging portion of the first electrical pin to pass therethrough and lock the stem-shaped portion of the locking engaging portion by the locking flange.

17. The socket connector of claim 16, wherein the locker includes a pair of elastic arms extending from the main body and separated from each other, each elastic arm has a hook member extending towards the other elastic arm at a free end.

18. The socket connector of claim 17, wherein the locker includes an operating portion on a side of the main body opposite to the pair of elastic arms.

19. The socket connector of claim 18, wherein the locking cavity has a guiding block and a stopping block, the stopping block is closer to the first socket than the guiding block, the hook members are between the guiding block and the stopping block.

20. The socket connector of claim 19, wherein the hook members move away from each other under guidance of the guiding block as the locker moves from the first position to the second position, and the hook members move toward each other under guidance of the guiding block as the locker moves from the second position to the first position.
